(19) United States
(12) Patent Application Publication
(10) Pub. No.: US 2021/0169205 A1
(43) Pub. Date: Jun. 10, 2021

(54) Device Having a Beverage Container Holder and a Beverage Holder

(71) Applicant: EVO GmbH, Oberschleissheim (DE)

(72) Inventor: Reinhold Eisenreich, Langenpreising (DE)

(21) Appl. No.: 17/265,736

(22) PCT Filed: Jul. 24, 2019
(86) PCT No.: PCT/EP2019/069942

§ 371 Date: Feb. 3, 2021

(30) Foreign Application Priority Data
Aug. 3, 2018 (DE) 20 2018 003 627.7
Jan. 9, 2019 (DE) 10 2019 100 399.7

(51) Int. Cl. A45F 5/00

(52) U.S. Cl. CPC A45F 5/00; B62J 11/00

(57) ABSTRACT

There is provided an apparatus having a beverage container holder and a beverage container, wherein the beverage container holder has a holding device for arranging the beverage container holder on a receptacle, and has a receiving device for detachably fixing the beverage container in place. The beverage container has an internal recess for receiving a liquid, and has an arrangement device designed to be complementary in shape and area to the receiving device. A magnetic device is provided on the receiving device and/or the arrangement device for their mutually detachable fixing. The arrangement device of the beverage container extends from a bottom side of the beverage container toward the internal recess, and has at least one surface area facing toward the receiving device, and the surface area corresponds to at least one segment of an outer surface of an ellipsoidal body.

### BACKGROUND OF THE INVENTION

### Field of the Invention

The present invention relates to an apparatus having a beverage container holder and a beverage container, wherein the beverage container holder has a holding device for arranging the beverage container on a receptacle. The apparatus has a receiving device for detachably fixing the beverage container in place, and the beverage container has an internal recess for receiving a liquid, and has an arrangement device designed to be complementary in shape and area to the receiving device. A magnetic device is provided on at least one of the receiving device and the arrangement device for their mutually detachable fixing.

### Background Information

Devices having a beverage container holder and a beverage container have already become known on the market in various versions. These devices usually have the property that the beverage containers in the form of drinking bottles, for example, can easily be removed from the beverage container holder, but putting the container back into the holder regularly proves to be awkward.

From U.S. Pat. No. 4,976,385 B1, a beverage container holder became known, to which a beverage container can be fixed by means of permanent magnets provided on the holder.

Similarly, from U.S. Patent Application Publication 2011/0147424 A1, a system of a beverage container holder and a beverage container became known, where the beverage container can be fixed to the holder by means of permanent magnets. Such a device can be used on a bicycle, for example, which can also be a mountain bike, which is moved on rough terrain and where the user of the bicycle would like to take out the beverage container to drink liquid during the journey, and then also put the container back in the holder. Since this must be done quickly and easily, so that the user can use both hands again to steer the bicycle, the possibility of quickly positioning the beverage container on the holder is on the one hand necessary, and it must also be ensured that the beverage container then positioned on the holder is securely fixed even when moving the bicycle on rough terrain and that there is no danger of the container detaching from the holder on its own.

In the system described above, a groove for receiving a permanent magnet is provided on the outside of the beverage container, which permanent magnet can cooperate with a permanent magnet for fixing the container to the holder, wherein the holder has a rail which is complementary in shape and area to the groove provided on the beverage container. This known system has the disadvantage that a positioning of the container on the holder is made difficult. If the beverage container is positioned with its longitudinal groove at an angle to the rail of the holder, an easy positioning of the container on the holder is not possible and the container must then be precisely oriented relative to the rail.

With the foregoing background, the present invention was developed to provide an apparatus having a beverage container holder and a beverage container, which eliminates the above-mentioned disadvantages and ensures that the beverage container can be easily positioned on the beverage container holder; the beverage container is securely fixed to the beverage container holder even if impacts or force impulses occur during the use of the apparatus. The invention created for the solution of this object has the features and advantages specified in the claims.

### SUMMARY OF THE DISCLOSURE

The present invention is of an apparatus having a beverage container holder and a beverage container, wherein the beverage container holder has a holding device for arranging the beverage container on a receptacle, and has a receiving device for detachably fixing the beverage container. The beverage container has an internal recess for receiving a liquid, and has an arrangement device designed to be complementary in shape and area to the receiving device. A magnetic device is provided on at least one of the receiving device and the arrangement device for their mutually detachable fixing, wherein the arrangement device of the beverage container extends from a bottom side of the beverage container in the direction of the internal recess, and has at least one surface area facing the receiving device. The surface area corresponding to at least one segment of an outer surface of an ellipsoidal body.

This configuration ensures that the beverage container can easily be fixed to the beverage container holder, because the arrangement device with its configuration, which has a recess that corresponds to the outer contour of at least one area of an inscribed ellipsoidal body, can easily be fixed to the receiving device. The receiving device is designed to be complementary in shape and area, of the holder, and due to this design, an automatically centring and positive-locking fixing of the container on the holder is achieved, regardless of whether the container is positioned on the holder at an angle or laterally offset, when the user wants to put the container back on the holder.

### BRIEF DESCRIPTION OF THE SEVERAL VIEWS OF THE DRAWING

The invention is explained in more detail with reference to the drawings. The drawings show in:

FIG. 1 is a side partial sectional view of an embodiment of an apparatus according to the invention, having a down tube of a mountain bike depicted in sections;

FIG. 2 is a perspective view of the beverage container holder of the embodiment of the apparatus shown in FIG. 1;

FIG. 3 is a sectioned perspective view of the beverage container according to FIG. 1;

FIG. 4 is a perspective view of a beverage container holder of an apparatus of a second embodiment of the present invention;

FIG. 5 is a partially sectioned perspective view of the second embodiment of the present invention, having a beverage container arranged on a beverage container holder;

FIG. 6 is a view of the second embodiment of the invention, as it is arranged on a dashboard of a motor vehicle (not depicted in more detail);

FIG. 7 is a schematic sectional view of a beverage container arranged on the receiving device in the position with positive-locking engagement between both components, according to the present invention;

FIG. 8 is a view similar to the one seen in FIG. 7, showing how the beverage container separates from the receiving device when it is rotated relative to the latter;

FIG. 9 is a schematic sectional depiction similar to the one seen in FIG. 7, showing how the beverage container separates when rotated relative to the receiving device in a second embodiment of the starting bevel; and

FIG. 10 is a schematic sectional depiction similar to the one seen in FIG. 7, showing how the beverage container separates when rotated relative to the receiving device in a third embodiment of the starting bevel.

### DETAILED DESCRIPTION OF PREFERRED EMBODIMENTS

There is provided according to the present invention an apparatus having a beverage container holder and a beverage container. The beverage container holder has a holding device for arranging the beverage container on a receptacle, and has a receiving device for detachably fixing the beverage container. The beverage container defines an internal recess for receiving a liquid, and has an arrangement device designed to be complementary in shape and area to the receiving device. A magnetic device is provided on at least one of the receiving device and the arrangement device for their mutually detachable fixing. The arrangement device of the beverage container extends from a bottom side of the beverage container in the direction of the internal recess, and has at least one surface area facing the receiving device. The surface area corresponds to at least one segment of an outer surface of an ellipsoidal body.

This configuration ensures that the beverage container can easily be fixed to the beverage container holder, because the arrangement device with its configuration, which has a recess that corresponds to the outer contour of at least one area of an inscribed ellipsoidal body, can easily be fixed to the receiving device. The receiving device is designed to be complementary in shape and area, of the holder, and due to this design, an automatically centered and positive-locking fixing of the container on the holder is achieved, regardless of whether the container is positioned on the holder at an angle or laterally offset, when the user wants to put the container back on the holder.

The recess on the container corresponding in this way to at least one section of a negative form of an ellipsoidal body ensures that the container, during its relative movement on the holder in the direction of movement for positioning the container on the holder, also undergoes a change in the angular offset of the longitudinal central axis of the container relative to the longitudinal central axis of the holder. This occurs even if the orientation is initially angular; furthermore, the angular offset is reduced as the movement progresses in the direction of the positioning of the container on the holder, until finally both longitudinal central axes coincide and the container is securely fixed to the holder.

It is provided according to a further aspect of the invention that the surface area corresponds to a segment of an outer surface of an elliptical paraboloid. This configuration ensures quick compensation of any angular offset in the direction of movement of the container for positioning on the holder, and a long contact surface of the recess of the container in the direction of the longitudinal central axis of the container for the receiving device of the holder, and thus long centring surfaces in the longitudinal central axis direction of the container.

It is generally provided, according to another aspect of the invention, that the arrangement device has a recess which corresponds to a rotation surface which is formed by rotating the surface area around a longitudinal central axis of the beverage container. This creates a recess which corresponds to a negative form of an ellipsoidal body and thus achieves that, regardless of the spatial direction in which an angular offset of the longitudinal central axis of the beverage container exists relative to the longitudinal central axis of the holder or the receiving device of the holder when positioning the container on the holder, a secure positioning of the container on the holder is achieved.

By means of at least one magnetic device provided on the receiving device and/or the arrangement device, it is achieved that, after positioning the container on the holder, the container is securely fixed on the holder by means of magnetic force. Even in the case of corresponding force impulses which act on the receptacle during the use of the apparatus according to the invention, an unintentional detaching of the container from the holder is avoided.

The afore-described configuration also ensures that, when the end position is reached between the container and the holder, i.e., when the axial relative movement of the container to the holder has come to a standstill when positioning the container on the holder, an audible “click” is emitted as an acoustically perceived signal to the user. Thus, the user knows that the container is securely fixed to the holder, without him/her having to check visually. Two magnetic devices can thus be provided, or even just one, which is provided on the holder, for example, and interacts with a container which has at least one section of material interacting with the magnetic device.

According to a further aspect of the invention, the arrangement device has an area provided with a flattened section at an end area spaced apart from the bottom side. A disc-shaped permanent magnet can be arranged on or in this area with the flattened section, for example, which interacts with a permanent magnet on the holder or the receiving device of the holder for securely fixing the container to the holder.

According to a further aspect of the invention, the receiving device is arranged spaced apart from the holding device; a receiving area is formed or defined between the receiving device and the holding device, which space is designed to receive a section of the beverage container. This configuration ensures that the lateral distance between the receiving device and the holding device creates a clearance for positioning the container from the holder from every spatial direction, for positioning the container on the holder, such that it makes no difference with which hand or from which direction the user positions the container on the holder.

According to a further aspect of the invention, the receiving device is formed in one piece with the holding device, and a connecting section is provided between the receiving device and the holding device. This integral design enables the beverage container holder to be manufactured from a plastic material in one-piece and at low cost, for example, such that the beverage container is completed after forming the holder from the tool mould without further processing steps on the receiving device.

According to a further aspect of the invention, the receiving device has at least one first holding section which is complementary to the shape and surface of the surface area, and which is formed for the positive-locking receiving of a section of the surface area of the beverage container. This configuration ensures that, by means of only one first holding section (which is strip-shaped, for example, which corresponds to a strip-shaped section of the outer surface of an ellipsoidal body), a positive-locking surface for positioning and aligning the container on the holding section is provided. This is accomplished without the receiving device having to have an outer surface which must correspond to a completely peripheral outer surface of an ellipsoidal body, for example from its end area to, for example, half the longitudinal extension of the ellipsoidal body.

Like the flattened section provided on the container or the recess of the container, the receiving device preferably has an end area provided with a flattened section, which is provided at a distance from the connecting section. On this end area, a permanent magnet can be arranged, for example, which interacts with a permanent magnet in the area of the flattened section of the arrangement device of the beverage container for detachably fixing both parts to each other.

According to a further aspect of the invention, the receiving device preferably has at least one second holding section which is complementary in shape and surface to the surface area, and which is designed for the positive-locking receiving of a section of the surface area of the beverage container. An end area provided with the flattened section is arranged between the first holding section and the second holding section. In this way, at least one spoke-shaped or strip-shaped holding section can be provided between the flattened section and the holding device, with which the beverage container holder can be arranged—for example, on a receptacle in the form of a bicycle frame or a dashboard of a vehicle—said holding section serving for the centring arrangement of the container on the holding device. Also, at least one second spoke-shaped or strip-shaped holding section is provided, which starts from the flattening section and is arranged opposite the at least one first holding section with respect to the flattening section, and serves for the centring arrangement of the container. The respective holding sections thus serve for the automatic centring arrangement and alignment of the container on the holding device, without the user of the apparatus having to visually check the correct orientation of the container to the holding device when arranging the container on the holding device (which is the case in the known system mentioned above).

According to a further aspect of the invention, the apparatus has a starting bevel on the arrangement device and/or the receiving device, which is configured in such a way that a rotation of the beverage container relative to the receiving device of the beverage container holder enlarges a clear distance between the magnetic device on the beverage container holder and the beverage container. For this purpose, the starting bevel can be designed in the form of a profile which is triangular or wavy in section, and is arranged on the receiving device, which is provided for positive-locking engagement with the wave-shaped profile in the area of the bottom of the beverage container holder. This configuration ensures that the user, when he or she wants to remove the beverage container from the holding device, enlarges the clear space between the container and the holding device by means of a rotation of the beverage container relative to the holding device. Thus, the magnetic force between the container and the holding device is reduced, and the user can then separate the container from the holding device without great effort, and thus it does not result in a sudden and unexpected detaching of the container from the holding device. This configuration is advantageous, for example, if the apparatus according to the invention, configured as a cup holder on the dashboard of a vehicle, is used; this prevents a detaching of the container in the form of a cup from the holding device, avoiding an unintentional spilling of liquid from the inside of the cup.

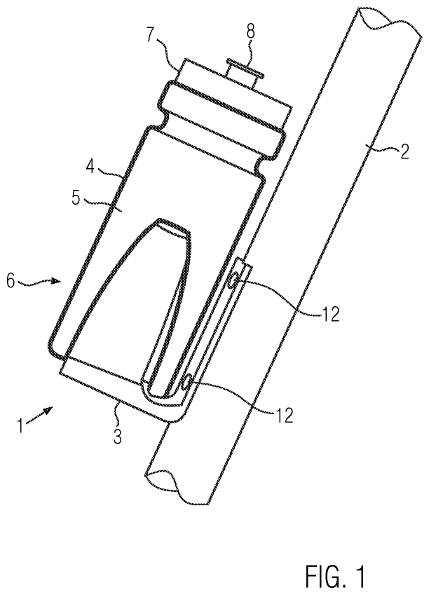

FIG. 1 is a sectional depiction of a first embodiment of an apparatus 1 according to the present invention, arranged on a down tube 2 of a mountain bike (not depicted in more detail). The apparatus 1 has a beverage container holder 3 and a beverage container 4 in the form of a drinking bottle. The drinking bottle 4 has or defines an inner recess 5 for receiving liquid, for example water, which fills the full interior space 6 of the drinking bottle 4. On the upper side of the drinking bottle 4, a lid 7 is provided in the form of a screw cap, on which a drinking nozzle 8 is provided, and which can be opened to remove liquid from the drinking bottle 4 and then closed again.

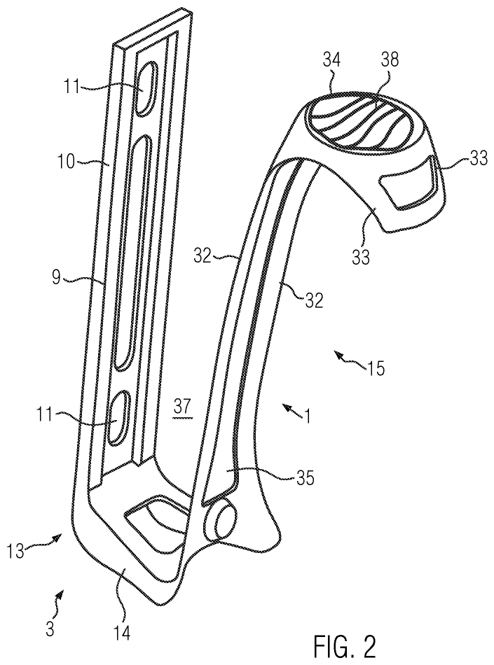

The beverage container holder 3 depicted in more detail in FIG. 2 has a holding device 9 in the form of an elongated holding bracket 10, which has two openings 11, through which two screw bolts 12 can be pushed, with which the beverage container holder 3 can be detachably fixed on the down tube 2. As can be seen in more detail in FIG. 2, a connecting section 14 extends from a lower area 13 of the beverage container holder 3 at a substantially right angle in one piece away from the holding bracket 10, on which a receiving device 15 is disposed in one piece with the connecting section 14, which serves to detachably fix the beverage container holder 4.

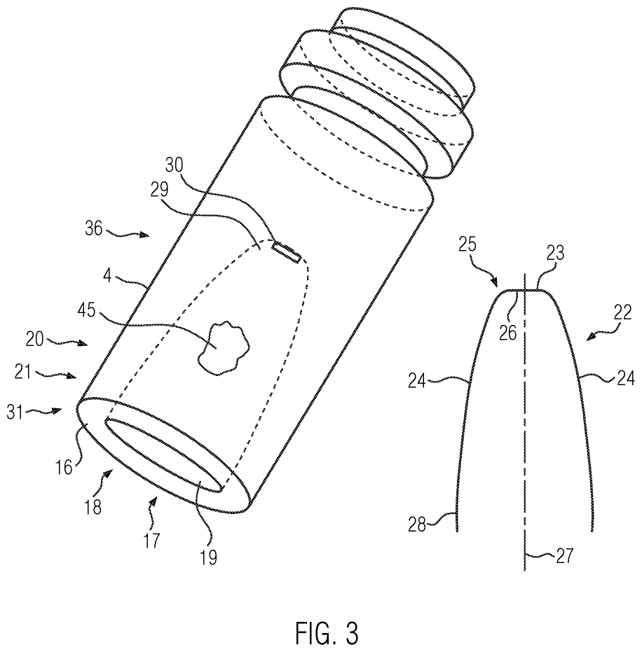

FIG. 3 shows a sectional depiction of the beverage container 4, as it is depicted in FIG. 1, in a position detached from the beverage container holder 3. As is readily apparent, an arrangement device 17 extends from a bottom side 16 of the beverage container 4, towards the inner recess 5 of the beverage container 4. The arrangement device 17 forms a recess 18, which extends into the inner recess 5 of the drinking bottle 4, and whose inner surface 19 corresponds to an outer surface of an ellipsoidal body inscribed or otherwise defined in the bottom area 20 of the beverage container 4. For the sake of illustration, the ellipsoidal body is, in the selected embodiment, also depicted as an elliptical paraboloid 22 having a flattened section (on the upper side in the drawing plane as a sectional depiction in FIG. 3). In the clearance of the recess 18, a bicycle inner tube (not shown in more detail) or a compressed air cartridge for filling a bicycle inner tube, or the like, can be accommodated, for example.

The elliptical paraboloid 22 has, in the sectional depiction, parabolic segment-shaped sides 24. The sides 24 are connected to a segment 26 on the upper side 25, and thus form an intersection curve 28, such that the elliptical paraboloid 22 emerges as a rotational body by rotating the intersection curve 28 around the longitudinal central axis 27. If, hypothetically, the resulting elliptical paraboloid 22 is inserted or inscribed as a three-dimensional body into the bottom area 20 of the beverage container 4—for example as a negative form—and the beverage container 4 with its inner recess 5 is formed around this elliptical paraboloid 22 as a molded body (for example by means of an extrusion process), a recess 18 is defined in the beverage container 4. The recess 18 has an inner surface which corresponds to an outer surface of an ellipsoidal body 21 inscribed into the bottom area 20, in the form of an elliptical paraboloid 22. Thus, the arrangement device 15 of the beverage container 4 has at least one surface area 45, as a section outlined in FIG. 3, which corresponds to a segment of an outer surface of an ellipsoidal body 21 inscribed into the bottom area 20.

In a flattened area 29 formed by a flattened section 23, a magnetic device 30 configured as a disc-shaped body can be used.

The arrangement device 17 of the beverage container 4 configured in this way thus has surface areas 31 with the inner surface 19, which face the receiving device 15 of the beverage container holder 3 and correspond to an outer surface of an ellipsoidal body 21.

The receiving device 15 of the beverage container holder 3 is described in more detail with reference to FIG. 2. In the embodiment of the beverage container holder 3 depicted in FIG. 2, the receiving device 15 has two first holding sections 32 formed in one piece with the connecting section 14, and two second holding sections 33 to detachably fix the beverage container 4 which start from an area with a flattened section 34, up to which the two first holding sections 32 extend from the connecting section 14. The second holding sections 33 are also formed in one piece with the flattened section 34.

As can be seen from FIG. 2, the first two holding sections 32 have a strip-shaped configuration, and have a form which is complementary in shape and surface to the inner surface 19 of the beverage container 4. Between the two first holding sections 32, a clearance 35 is defined which, together with the two first holding sections 32, forms a surface which—if the clearance 35 as a physical surface connected the two holding sections 32—would form a strip-shaped segment from the outer surface of an elliptical paraboloid 22. Because the inner surface 19 of the beverage bottle 4 is supported by the two strip-shaped holding sections 32 and the holding sections 33 when it is arranged on the receiving device 15, it results in a positive-locking automatic centring of the beverage bottle 4 on the receiving device 15; this is regardless of the starting angle at which the user of the apparatus initially places the beverage bottle 4 on the receiving device 15.

An axial movement of the beverage bottle 4 in the direction of the connecting section 14 results in the outer shell 36 of the beverage container 4 being received in the receiving area 37, which is formed between the holding bracket 10 and the two holding sections 32, and thus an automatic centring of the beverage container 4 relative to the receiving device 15 occurs. On the flattened section 34 of the receiving device 15, a permanent magnet 38 is provided. It interacts with the permanent magnet 30 of the beverage container 4, in such a way that the beverage container 4 is fixed securely on the receiving device 15, and cannot detach itself from it on its own.

By means of a design of the apparatus 1 in such a way that the contact surfaces assigned to each other come into direct contact with each other between the permanent magnet 30 and the permanent magnet 38, if the beverage container 4 is arranged on the beverage container holder 3, it results in a noise which can be acoustically perceived as a “click” when the two permanent magnets rest on each other. Thus the user of the apparatus 1 according to the invention experiences acoustic feedback that the beverage container 4 is securely fixed to the beverage container holder 3, without the need for a visual check by the user. This noise thus leads to a confirmation of secure holding which can be easily determined by the user of the apparatus 1.

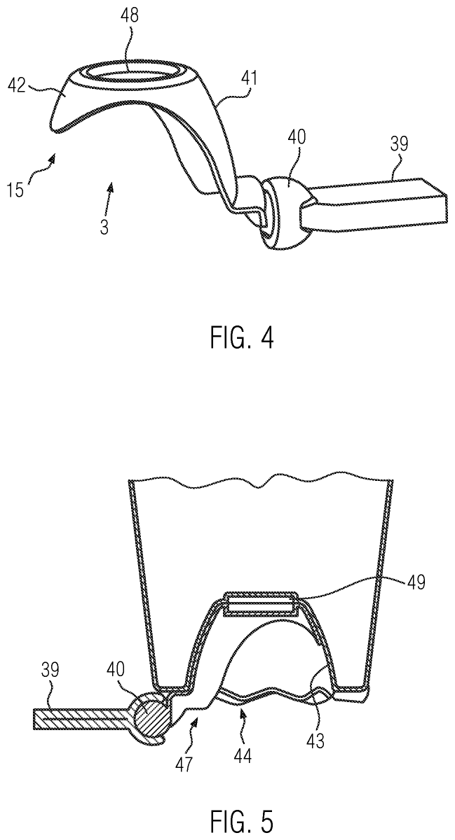

FIG. 4 shows a beverage container holder 3 according to a modified embodiment of the apparatus, which is provided to arrange the apparatus 1, for example, on a dashboard of a motor vehicle. The vehicle is not depicted in more detail. By means of the holding device 39, which is depicted schematically, the beverage container holder 3 can be fixed on the dashboard. By means of a ball joint 40 provided between the receiving device 15 and the holding device 39, the angular orientation between the receiving device 15 and the holding device 39 can be set, to take into account the arrangement point on the dashboard not depicted in more detail or its orientation relative to the vertical.

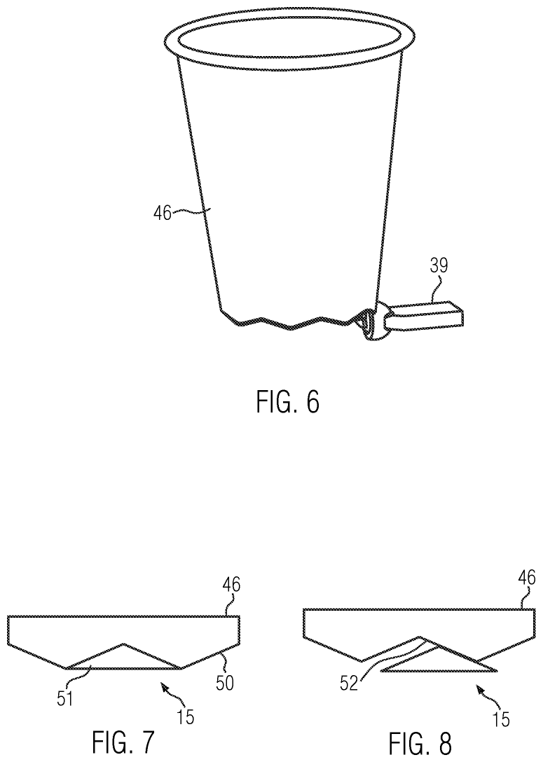

Distinct to the embodiment of the apparatus according to the invention having a beverage container in the form of a drinking bottle 4, in the embodiment of the beverage container holder 3 depicted in FIG. 4 the receiving device 15 is in the form of surface elements 41, 42, which are again configured to be complementary in shape and contour to an inner surface 43 (which can be seen in more detail in FIG. 5), of a recess 44 on the beverage cup 46, which can be seen in more detail in FIG. 6. The effect of the receiving device 15 and the recess 44 corresponds to the description explained above; thus, an automatic centring between the beverage container 46 or its arrangement device 47 and the receiving device 15 also here takes place. As can be seen in FIG. 4, a recess 48 is formed on the upper end area of the receiving device 15, in which recess a permanent magnet (not depicted in more detail) can be arranged; also, the beverage cup 46 has a recess 49 in the upper end area of the recess 44, in which recess 49 a permanent magnet also not depicted in more detail can be arranged, such that the beverage container 46 is securely fixed to the receiving device 15.

FIG. 7 shows a schematic sectional depiction of a beverage container arranged on the receiving device 15 in the form of the beverage container holder 46 in the position with positive-locking engagement between both components. As can be readily seen, the beverage cup 46 has a wave-shaped or triangular profile 50 on its underside, which is designed to be complementary in shape and surface contour to a triangular profile 51 formed on the receiving device 15. This configuration ensures that the two profiles 50, 51 come into positive-locking contact with each other, or engage in a positive-locking manner, in an arrangement of the beverage cup 46 on the arrangement device 15. This engagement is maintained because of the magnetic device.

When the user wants to separate the beverage cup 46 from the receiving device 15, he or she only has to rotate the beverage cup 46 relative to the receiving device 15, which causes the beverage cup 46 to be separated from the arrangement device 15 due to the starting bevel 52 formed by the two profiles 50, 51, that is, the clear distance between the beverage cup 46 and the receiving device 15 increases, and the user can easily remove the beverage cup 46 from the arrangement device without the risk of spilling any liquid in the beverage cup 46.

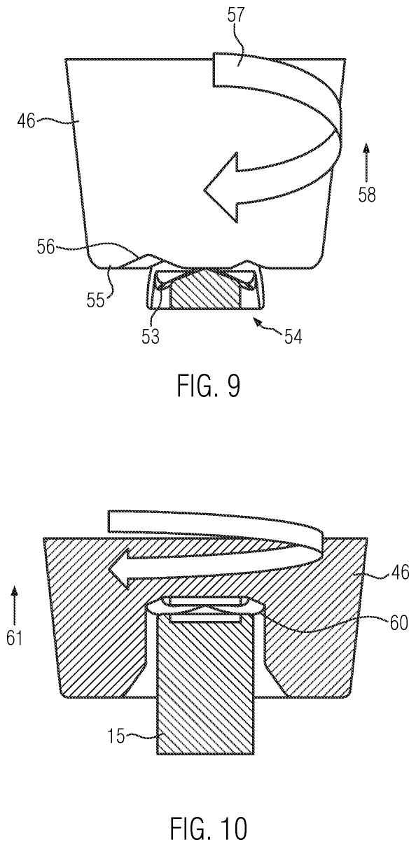

The configuration depicted in FIG. 9 has a similar effect. FIG. 9 shows a schematic sectional depiction similar to that illustrated in FIG. 7, and illustrates how the beverage container separates during a rotation relative to the receiving device in a second embodiment of the starting bevel. In the configuration depicted in FIG. 9, the receiving device 15 has a wave-shaped profile 54 formed on the upper side 53. The profile 54 has starting bevels 55 at an angle in the range of from about 15° to about 45°, such that the wave-shaped profile 56 formed on the underside or bottom side 55 on the beverage cup 46 engages in a positive-locking manner with the profile 54 provided with the starting bevels 55 during an intended positioning of the beverage cup 46 on the receiving device 15. If the user wants to remove the beverage cup 46 from the receiving device 15 according to FIG. 9, a rotation, depicted schematically by the arrow 57, of the beverage cup 46 relative to the receiving device 15 results in the beverage cup 46 separating from the receiving device in the direction depicted by the arrow 58, and the user can easily remove the beverage cup 46.

A similar effect is also achieved by the embodiment of the apparatus depicted in FIG. 10, which depicts a schematic sectional depiction similar to that of FIG. 7, which shows how the beverage container separates during a rotation relative to the receiving device according to the third embodiment of the starting bevel. The receiving device 15 according to the third embodiment depicted in FIG. 10 has a largely flat configuration in the form of a flat contact surface, with which a profile 60 (which is triangular or wave-shaped in section and formed in the area of the recess of the cup 46) comes into positive-locking contact when the cup is positioned on the receiving device 15 as intended. If the user wants to separate the cup 46 from the receiving device 15, a rotation of the cup by a small angle range relative to the receiving device 15 again causes the cup 46 to separate from the receiving device in the direction of the arrow 61; the clear distance between the receiving device 15 and the beverage cup 46 increases and thus the effect of the magnetic device provided on the two components decreases, and the user can easily remove the cup from the receiving device 15 without the risk of liquid spilling out of the beverage cup 46. This embodiment is suitable, for example, for positioning the receiving device 15 in the area of a center console of a vehicle (vehicle not shown in detail) and can be recessed in the center console when it is not needed, and can be extended from the center console by means of a push-push operation—so that the beverage cup 46 can be positioned on the receiving device.

The invention is characterised by, among others, the fact that due to the design of the beverage container holder and the beverage container according to the invention, an automatically centring configuration is created, and the beverage container is securely fixed on the holder by means of the permanent magnets. Security is offered even when the apparatus is used on a vehicle which is used on rough terrain, for example, such as a mountain bike or another off-road vehicle in the form of an SUV.

The beverage container can, for example, be formed by means of an extrusion blow moulding process, and during its manufacture, the ellipsoidal indentation can be formed with it. With respect to features of the invention not explained individually in more detail above, reference also is made to the claims and the drawings.

### REFERENCE NUMERAL LIST

1. Device or apparatus
2. Down tube, receptacle
3. Beverage container holder
4. Beverage container, drinking bottle
5. Internal recess
6. Interior space
7. Lid
8. Drinking nozzle
9. Holding device
10. Holding bracket
11. Opening
12. Screw bolts
13. Area
14. Connecting section
15. Receiving device
16. Bottom side
17. Arrangement device
18. Recess
19. Inner surface
20. Bottom area
21. Ellipsoidal body
22. Elliptical paraboloid
23. Flattened section
24. Side
25. Upper side
26. Segment
27. Longitudinal central axis
28. Intersection curve
29. Flattened area
30. Magnetic device
31. Surface area
32. First holding section
33. Second holding section
34. Flattened section
35. Clearance
36. Outer shell
37. Receiving area
38. Permanent magnet
39. Holding device
40. Ball joint
41. Surface element
42. Surface element
43. Inner surface
44. Recess
45. Surface area
46. Beverage cup
47. Arrangement device
48. Recess
49. Recess
50. Profile
51. Profile
52. Starting bevel
53. Upper side
54. Profile
55. Bottom side
56. Profile
57. Profile
58. Arrow
59. Upper side
60. Profile
61. Cup

What is claimed is:

1. An apparatus having a beverage container holder and a beverage container, wherein the beverage container holder has a holding device for arranging the beverage container holder on a receptacle, and a receiving device for detachably fixing the beverage container in place; and wherein the beverage container defines an internal recess for receiving a liquid, and comprises an arrangement device formed to be complementary in shape and area to the receiving device; and a magnetic device is provided on at least one of the receiving device and the arrangement device for their mutually detachable fixing;
wherein the arrangement device of the beverage container extends from a bottom side of the beverage container towards the internal recess, and comprises at least one surface area facing towards the receiving device, said surface area corresponding to at least one segment of an outer surface of an ellipsoidal body.

2. The apparatus according to claim 1 wherein the surface area corresponds to a segment of an outer surface of an elliptical paraboloid.

3. The apparatus according to claim 1 wherein the arrangement device defines a recess which corresponds to a rotational surface which is formed by rotating the surface area around a longitudinal central axis of the beverage container.

4. The apparatus according to claim 3 wherein the arrangement device has an area provided with a flattened section on an end area distanced from the bottom side.

5. The apparatus according to claim 1 wherein the arrangement device has an area for arranging a magnetic device.

6. The apparatus according to claim 1 wherein the receiving device is distanced from the holding device, and a receiving area is defined between the receiving device and the holding device for receiving a section of the beverage container.

7. The apparatus according to claim 1 wherein the receiving device is formed integrally with the holding device, and a connecting section is disposed between the receiving device and the holding device.

8. The apparatus according to claim 1 wherein the receiving device comprises at least one first holding section complementary in shape and surface contour to the surface area, said first holding section adapted for the positive-locking reception of a section of the surface area of the beverage container.

9. The apparatus according to claim 8 wherein the receiving device comprises an end area having a second flattened section, said end area disposed a distance from the connecting section.

10. The apparatus according to claim 5 wherein the receiving device has an area for arranging a magnetic device.

11. The apparatus according to claim 9 wherein the receiving device has at least one second holding section complementary in shape and area to the surface area, said second holding section formed to receive, in a positive-locking manner, a section of the surface area of the beverage container, and the end area provided with the second flattened section is between the first holding section and the second holding section.

12. The apparatus according to claim 1 wherein the receiving device and the arrangement device are adapted so that a movement of the beverage container relative to the beverage container holder automatically centers the beverage container on the receiving device by a contact of the arrangement device with the receiving device.

13. The apparatus according to claim 12, further comprising a starting bevel on the arrangement device or the receiving device, adapted so that a rotation of the beverage container relative to the receiving device enlarges a clear distance between the magnetic device and the beverage container.

14. The apparatus according to claim 13 wherein the starting bevel defines a profile, triangular or wave-shaped in section, on the receiving device, said profile for positive-locking engagement with a wave-shaped profile in an area of the bottom of the beverage container.

15. The apparatus according to claim 12 wherein the beverage container comprises a drinking bottle or drinking cup.
